(19) United States
(12) Patent Application Publication
(10) Pub. No.: US 2010/0312405 A1
(43) Pub. Date: Dec. 9, 2010

(54) FLUID CONTROL METHOD, FLUID CONTROL SYSTEM, AND NON-TRANSITORY COMPUTER-READABLE MEDIUM STORING FLUID CONTROL PROGRAM

(75) Inventors: Tetsujiro KONO, Nagoya-shi (JP); Minoru Itoh, Kasugai-shi (JP)

Correspondence Address: OLIFF & BERRIDGE, PLC, P.O. BOX 320850, ALEXANDRIA, VA, 22320-4850, US

(73) Assignee: CKD CORPORATION, Komaki-shi (JP)

(21) Appl. No.: 12/787,762

(22) Filed: May 26, 2010

(30) Foreign Application Priority Data
Jun. 4, 2009 (JP) 2009-135194

(51) Int. Cl. G05D 11/02; G05D 7/00; G05D 16/00

(52) U.S. Cl. 700/285; 700/282

(57) ABSTRACT

A fluid control method for maintaining a split flow ratio of main gas to be split from a main line into first and second sublines constant before and after additive gas is supplied to one of the sublines is achieved by controlling a flow rate of the main gas to be supplied from the main line to a chamber through the first and second sublines based on the pressure in each of the first and second sublines when the additive gas is to be supplied to the second subline. The pressure in the first subline not supplied with the additive gas is controlled to remain constant during supply of the additive gas to the second subline.

### CROSS-REFERENCE TO RELATED APPLICATIONS

This application is based upon and claims the benefit of priority from each of the prior Japanese Patent Application No. 2009-135194 filed on Jun. 4, 2009, the entire contents of which are incorporated herein by reference.

### TECHNICAL FIELD

The present invention relates to a fluid control method, a fluid control system, and a non-transitory computer-readable medium storing fluid control program for dividing or splitting a flow of main gas into two lines or circuits and controlling a flow rate of the main gas to be supplied through each line or circuit based on pressure or flow rate in each line or circuit.

### BACKGROUND ART

For a semiconductor manufacturing process, for example, there is a demand for high flatness of wafer in association with improved machining accuracy. An etching device is configured to divide or split a predetermined amount of main gas flowing in a main line into two flows in a first subline and a second subline and distribute the main gas on a central portion and an edge portion of the wafer respectively. The flow rate of the main gas flowing in each of the first and second sublines is controlled by a fluid control system to distribute or spray the main gas evenly over the wafer.

A conventional fluid control system is configured such that, taking account into consideration that the flow rate and the pressure of the main gas flowing in the first and second sublines, a pressure ratio between the first and second sublines needed for evenly distributing the main gas on both the central portion and the edge portion of the wafer is stored in advance, and the pressure in each of the first or second subline is controlled to keep an initial pressure ratio constant, thereby controlling the flow rate of the main gas to be supplied on the central portion and the edge portion of the wafer. To enhance the flatness of the wafer, it is preferable to adjust an etching rate (rate at which a film or layer is to be etched per unit of time) to be as uniform as possible between the central portion and the edge portion of the wafer. However, to further uniformize the etching rate, recently, it is necessary not only to control the flow rate but also to inject additive gas into one of the sublines (e.g., see Japanese Patent 4224492 (U.S. Pat. No. 7,353,841 B2)).

### SUMMARY OF INVENTION

### Technical Problem

In the conventional fluid control system, however, when the additive gas is injected into the one subline and hence the pressure in this sublime increases, an amount of the main gas to be supplied to the other subline is increased to increase the pressure in this subline in order to maintain the initial pressure ratio. As a result, the flow rate of main gas in the former subline is decreased, whereas the flow rate of main gas in the latter sublime is increased. Thus, a split flow ratio of main gas to be supplied on the central portion and the edge portion of the wafer would change and the necessary flow rate of main gas could not be maintained.

The present invention has been made to solve the above problems and has a purpose to provide a fluid control method, a fluid control system, and a non-transitory computer-readable medium storing fluid control program, capable of maintaining a split flow rate of main gas to be split from a main line into first and second sublines before and after additive gas is supplied to one of the sublines.

### Solution to Problem

To achieve the purpose of the invention, there is provided A fluid control method for controlling a flow rate of main gas to be supplied from a main line to a chamber through first and second sublines divided from the main line based on pressure in each of the first and second sublines while the second subline is supplied with additive gas, wherein the pressure in the first subline not supplied with the additive gas is controlled to be constant during supply of the additive gas to the second subline.

According to another aspect of the invention, A fluid control method for controlling a flow rate of main gas to be supplied from a main line to a chamber through first and second sublines divided from the main line based on flow rate in each of the first and second sublines while the second subline is supplied with additive gas, wherein the flow rate in the first subline not supplied with the additive gas is controlled to be constant during supply of the additive gas to the second sublime.

According to another aspect of the invention, A fluid control system comprising: a main line, first and second sublines divided from the main line; a first pressure control unit placed in the first subline; a second pressure control unit placed in the second sublime; and a merging line connected to the second subline on a downstream side of the second pressure control unit to supply additive gas into the second subline, the system being configured to control a flow rate of main gas to be allowed to flow in each of the first and second sublines based on the pressure in each of the first and second sublines, wherein the additive gas is supplied into the second sublime while the pressure in the first sublime is controlled by the first pressure control unit to maintain the pressure in the first sublime constant.

According to another aspect of the invention, A fluid control system comprising: a main line, first and second sublines divided from the main line; a first flow rate control unit placed in the first subline; a second flow rate control unit placed in the second subline; and a merging line connected to the second subline on a downstream side of the second flow rate control unit to supply additive gas into the second subline, the system being configured to control a flow rate of main gas to be allowed to flow in each of the first and second sublines based on the flow rate in each of the first and second sublines, wherein the additive gas is supplied into the second subline while the flow rate in the first subline is controlled by the first flow rate control unit to maintain the flow rate in the first subline constant.

According to another aspect of the invention, A non-transitory computer-readable medium storing a fluid control program applicable to a fluid control system comprising: a main line, first and second sublines divided from the main line; a first pressure control unit placed in the first subline; a second pressure control unit placed in the second subline; a merging line connected to the second subline on a downstream side of the second pressure control unit to supply additive gas into the subline; and a computer for electrically controls the first and second pressure control unites based on the fluid control program, the system being configured to control a flow rate of main gas to be allowed to flow in each of the first and second sublines based on the pressure in each of the first and second sublines, wherein the program includes operating the computer to cause the first pressure control unit to control the pressure in the first subline to be maintained constant before the additive gas is supplied to the second subline.

According to another aspect of the invention, A non-transitory computer-readable medium storing a fluid control program applicable to a fluid control system comprising: a main line, first and second sublines divided from the main line; a first flow rate control unit placed in the first subline; a second flow rate control unit placed in the second sublime; a merging line connected to the second subline on a downstream side of the second flow rate control unit to supply additive gas into the second sublime; and a computer for electrically controls the first and second flow rate control unites based on the fluid control program, the system being configured to control a flow rate of main gas to be allowed to flow in each of the first and second sublines based on the flow rate in each of the first and second sublines, wherein, the program includes operating the computer to cause the first flow rate control unit to control the flow rate in the first sublime to be maintained constant before the additive gas is supplied to the second sublime.

### BRIEF DESCRIPTION OF DRAWINGS

FIG. 1 is a schematic configuration view of an etching system including a fluid control system in an embodiment of the invention;

FIG. 2 is a flowchart of a fluid control program;

FIG. 3 is a graph showing pressure variations in first and second sublines in the case where additive gas is injected into the second subline during execution of a pressure ratio control mode;

FIG. 4 is a graph showing pressure variations in the first and second sublines in the case where additive gas is injected into the second subline during execution of a pressure control mode;

FIG. 5 is a graph showing pressure variations in the first and second sublines in the case where disturbance occurs during execution of the pressure ratio control mode;

FIG. 6 is a schematic configuration view of another example of a fluid control system; and

FIG. 7 is a flowchart showing another example of the fluid control program.

### DESCRIPTION OF EMBODIMENTS

A detailed description of a preferred embodiment of a fluid control method, a fluid control system, and a non-transitory computer-readable medium storing fluid control program, embodying the present invention will now be given referring to the accompanying drawings.

<Entire Configuration of Etching System>

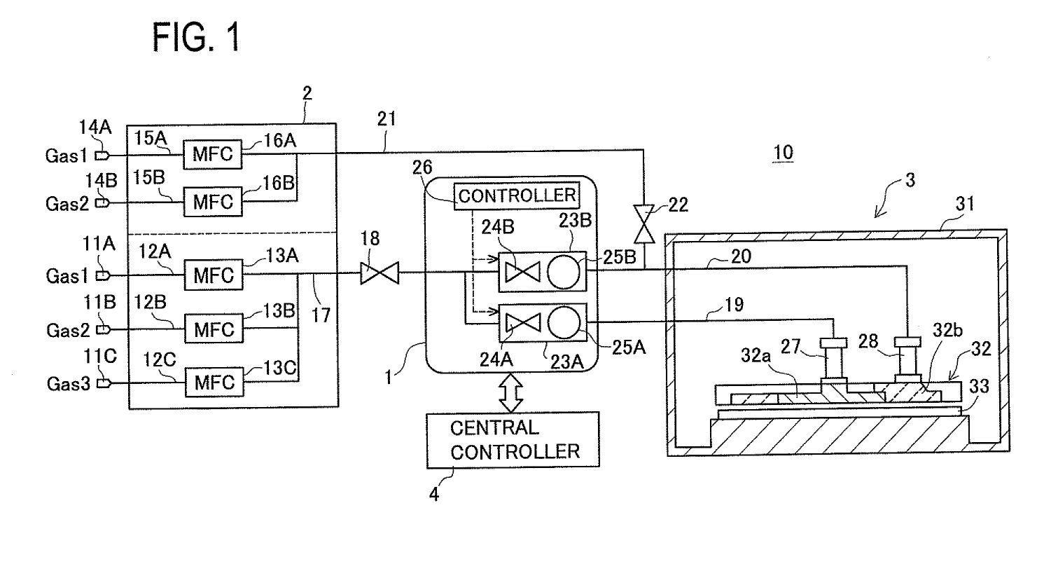

FIG. 1 is a schematic configuration view of an etching system 10 including a fluid control system 1 in this embodiment. This etching system 10 is used for a process of manufacturing semiconductors.

In the etching system 10, the fluid control system 1 is connected between a gas box 2 and an etching device 3 and is arranged to control a flow rate of main gas to be supplied to the etching device 3.

The etching device 3 is operated to create a vacuum in a chamber 31 by use of a vacuum pump not shown and then supply a predetermined amount of main gas to a wafer 33 through a shower plate 32, thereby etching the wafer 33. The shower plate 32 includes a first shower part 32a for distributing or spraying the main gas on a central portion of the wafer 33 and a second shower part 32b placed around the first shower part 32a to distribute or spray the main gas on an edge portion of the wafer 33.

In the gas box 2, there are provided a first mass flow controller (MFC) 13A for process gas placed on a first process gas line 12A connected to a first gas supply source 11A, a second MFC 13B for process gas placed on a second process gas line 12B connected to a second gas supply source 11B, and a third MFC 13C for process gas placed on a third process gas line 12C connected to a third gas supply source 11C. In the gas box 2, furthermore, there are provided a first MFC 16 for additive gas placed on a first additive gas line 15A connected to a first additive gas supply source 14A and a second MFC 16B for process gas placed on a second additive gas line 15B connected to a second additive gas supply source 14B.

The first to third process gas lines 12A to 12C are connected in parallel to a main line 17. A main valve 18 is placed on the main line 17 to control supply of the main gas made of a mixture of the process gases whose flow rates are controlled by the first to third MFCs 13A to 13C respectively. The main line 17 is divided into a first subline 19 and a second subline 20 on a downstream side of the main valve 18. The first subline 19 is connected to a first nozzle 27 connected to the first shower part 32a and the second subline 20 is connected to a second nozzle 28 connected to the second shower part 32b.

The first and second additive gas lines 15A and 15B are connected in parallel to a merging line 21. This line 21 is merged with the second sublime 20 on a downstream side of a second pressure controller 23B included in the fluid control system 1 to add additive gas to the main gas flowing in the second sublime 20. This supply of additive gas is controlled by a merging valve 22 placed on the merging line 21.

<Configuration of Fluid Control System>

The fluid control system 1 includes a first pressure controller 23A placed on the first subline 19 and the second pressure controller 23B placed on the second subline 20. In the first pressure controller 23A, a first pressure sensor 25A is placed downstream of a first fluid control valve 24A. The first fluid control valve 24A and the first pressure sensor 25A are connected to a controller 26. In the second pressure controller 23B, a second pressure sensor 23B is placed downstream of a second fluid control valve 24B. The second fluid control valve 24B and the second pressure sensor 23B are also connected to the controller 26. The controller 26 is a known computer and stores a fluid control program for controlling operations of the fluid control system 1. In the present embodiment, specifically, s fluid control program is stored in a recording medium built in the controller 26. As an alternative, the fluid control program may be stored in a recording medium readable by the controller 26 such as a FD, a CD-ROM, and others and executed by the controller 26. Upon receipt of a command from a central controller 4 that controls operations of a semiconductor apparatus, the controller 26 is activated and executes the fluid control program.

<Configuration of Fluid Control Program>

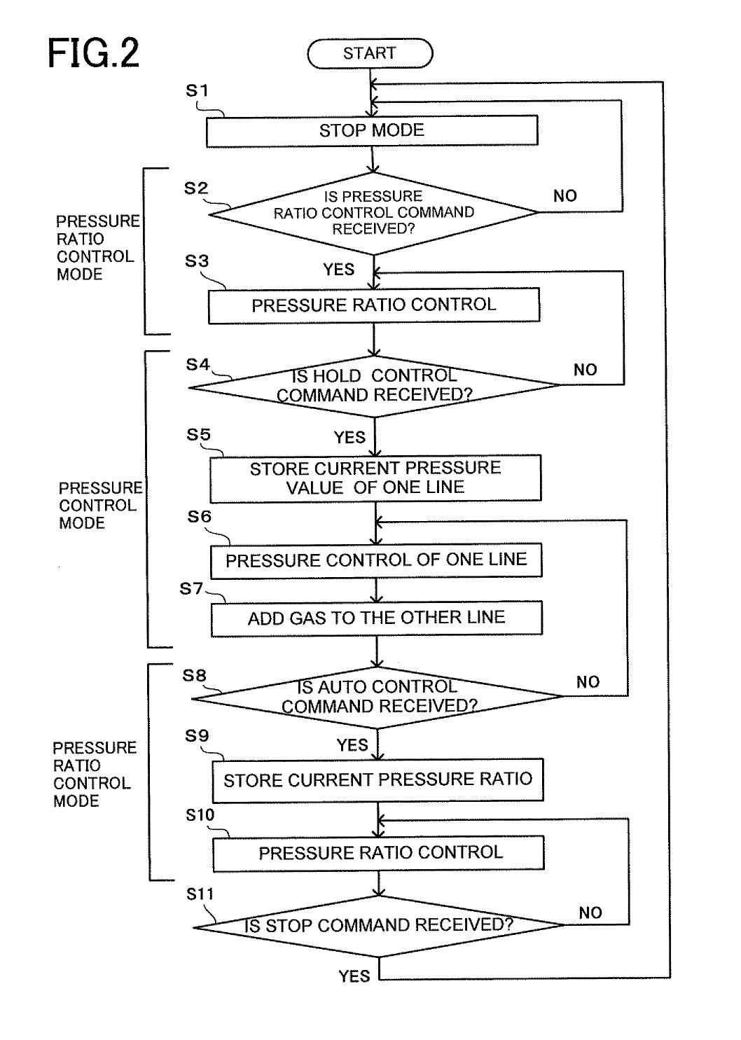

FIG. 2 is a flowchart of the fluid control program to be executed by the controller 26. Based on this program, in response to a command from the central controller 4, the controller 26 selectively performs a “pressure ratio control mode” of controlling the pressure in the first subline 19 or the second subline 20 based on a pressure ratio therebetween and a “pressure control mode” of controlling the pressure in the first sublime 19 to keep that pressure constant.

To be concrete, the controller 26 executes a stop mode at start-up (step 1 (S1)) and waits until receiving a pressure ratio control command from the central controller 4 (S2: NO). The pressure ratio control command is to be output from the central controller 4 to the controller 6 when an operator enters a command representing a pressure ratio to execute an etching work to the central controller 4. Specifically, the pressure ratio control command is to indicate a target pressure ratio to be used in the pressure ratio control and thereby cause the controller 6 to execute the pressure ratio control.

Upon receipt of the pressure ratio control command from the central controller 4, the controller 26 stores the target pressure ratio included in the pressure ratio control command as an initial pressure ratio (a first target pressure ratio) and performs pressure ratio control (S3). That is, the controller 26 controls open degrees of the first and second fluid control valves 24A and 24B and detects, through the first and second pressure sensors 25A and 25B, the pressures in the first and second sublines 19 and 20 respectively. When measured pressure values detected by the first and second pressure sensors 25A and 25B are transmitted to the controller 26, the controller 26 determines a pressure ratio, compares the pressure ratio with the previously stored first target pressure ratio, and adjusts the opening degree of the firs fluid control valve 24A or the second fluid control valve 24B so that the pressure ratio between the measured pressure values coincides with the first target pressure ratio.

The controller 26 continues the pressure ratio control until receiving a HOLD control command of maintaining the pressure in the first subline 19 constant from the central controller 4 (S4: NO, S3). The HOLD control command is to be output from the central controller 4 to the controller 26 when the operator enters a command to add additive gas to the main gas.

Upon receipt of the HOLD control command, the controller 26 switches from the pressure ratio control mode to the pressure control mode (S4: YES). Specifically, the controller 26 obtains a current pressure value of one line not connected to the merging line 21, that is, the first subline 19, from the first pressure sensor 25A and stores that pressure value (S5). The controller 26 feedback-controls the opening degree of the first fluid control valve 24A so that a pressure value measured by the first pressure sensor 25A coincides with the stored value (S6). Accordingly, the pressure of main gas allowed to flow in the first subline 19 is maintained constant. When starting the feedback control of the pressure in the first subline 19, the controller 26 outputs a signal indicating to that effect to the central controller 4. The merging valve 22 is thus opened to allow the additive to be supplied from the merging line 21 to the second subline 20 and mixed into the process gas (S7).

The controller 26 continues to execute the pressure control mode until receiving an AUTO control command from the central controller 4 (S8: NO, S6, S7). The AUTO control command is to be output from the central controller 4 to the controller 26 when the operator enters a command to the central controller 4 to switch from the HOLD control (the pressure control) to the pressure ratio control.

Upon receipt of the AUTO control command from the central controller 4 (58: YES), the controller 26 switches from the pressure control mode to the pressure ratio control mode. Specifically, the controller 26 receives the measured pressure values detected by the first and second pressure sensors 25A and 25B, determines a current pressure ratio based on the received measured pressure values, and stores the determined pressure ratio as a target pressure ratio set after supply of additive gas (hereinafter, referred to as a “second target pressure ratio”) (S9). The controller 26 then performs the pressure ratio control with reference to the second target pressure ratio (S10). The pressure ratio control in this case is identical to the pressure ratio control in S3 excepting for the use of the second target pressure ratio instead of the use of the first target pressure ratio, and thus the explanation of the details thereof is not repeated below.

The pressure ratio control using the second target pressure ratio as a reference is continuously performed until the controller 26 receives a stop command from the central controller 4 (S11: NO, S10). The stop command is to be output from the central controller 4 to the controller 26 when the operator enters a command to stop the work to the central controller 4. Upon receipt of the stop command from the central controller 4, the controller 26 returns to S1 and establishes the stop mode.

When the central controller 4 is shut down and no electric power is supplied to the controller 26, the controller 26 terminates the fluid control program.

<Fluid Control Method>

The following explanation is given to the fluid control method including the entire operations of the etching system 10.

While the etching system 10 is not activated, the controller 26 of the fluid control system 1 does not receive any command from the central controller 4 and thus does not execute the fluid control program. In this case, the fluid control system 1 does not operate the first and second fluid control valves 24A and 24B. In the etching system 10, the main valve 18 and the merging valve 22 are in closed state.

When the operator activates the central controller 4, the controller 26 is also supplied with electric power and activated and starts up the fluid control program shown in FIG. 2. At that time, the controller 26 executes the stop mode and does not operate the first and second fluid control valves 24A and 24B.

When the operator enters a command to execute an etching work, the central controller 4 outputs the pressure ratio control command to the controller 26. Upon receipt of the pressure ratio control command, the controller 26 adjusts the opening degrees of the first and second fluid control valves 24A and 24B based on the stored first target pressure ratio, thereby dividing a predetermined amount of the main gas flow from the main line 17 into two flows in the first and second sublines 19 and 20. The main gas is then supplied into the chamber 31 through the first and second nozzles 27 and 28 and the first and second shower parts 32a and 32b and then is discharged out.

The first and second pressure sensors 25A and 25B measure the outlet pressures of the first and second fluid control valves 24A and 24B, that is, the pressures of main gas to be supplied through the first and second sublines 19 and 20 to the first and second shower parts 32a and 32b. The controller 26 receives pressure values measured by the first and second pressure sensors 25A and 25B and determines a pressure ratio therebetween. When the pressures of main gas flowing in the first and second sublines 19 and 20 become stable at the first target pressure ratio, the controller 26 outputs a signal indicating to that effect to the central controller 4. The central controller 4, upon receipt of such signal, causes a display part such as a lamp or display to indicate that supply of additive gas is enabled to inform the operator thereof.

When the operator enters a command into the central controller 4 to supply additive gas, the central controller 4 outputs the HOLD control command to the controller 26. The controller 26, upon receipt of the HOLD control command, switches from the pressure ratio control mode to the pressure control mode to control the opening degree of the first fluid control valve 24A so that the pressure in the first subline 19 is constant before and after the supply of additive gas.

To be concrete, the controller 26 receives and stores the measured pressure value from the first pressure sensor 25A measuring the pressure in the first subline 19 to which the merging line 21 is not connected. The controller 26 thus controls the opening degree of the first fluid control valve 24A to keep the pressure value measured by the first pressure sensor 25A constant. When the measured pressure value in the first subline 19 becomes stable, the controller 26 outputs a signal indicating to that effect to the central controller 4. The central controller 4 having received such signal opens the merging valve 22 and supplies the additive gas fed from the first and second additive gas supply sources 14A and 14B to the second subline 20.

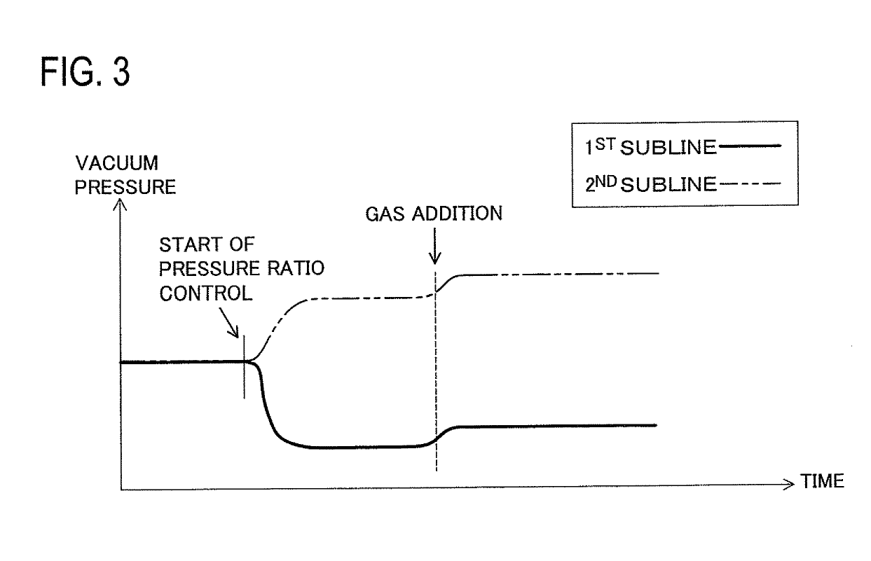

FIG. 3 is a graph showing pressure variations in the first and second sublines 19 and 20 in the case where additive gas is injected into the second subline 20 during execution of the pressure ratio control mode. In this graph, a vertical axis indicates vacuum pressure and a lateral axis indicates time. When the merging valve 22 is operated to supply the additive gas from the merging line 21 to the second subline 20, the pressure value measured by the second pressure sensor 25B increases as shown in FIG. 3. At that time, if the pressure ratio control mode is being executed, the opening degree of the first fluid control valve 24A is increased to adjust the pressure ratio between the first and second sublines 19 and 20 to be constant, so that the pressure value measured by the first pressure sensor 25A also increases. In other words, the flow rate of main gas flowing in the first subline 19 is increased. However, the pressure increase in the second subline 20 results from the supply of additive gas but not the increase in flow rate of main gas. Nevertheless, if the flow rate of main gas to be supplied to the first subline 19 is increased, a split flow ratio of main gas to be split into the first and second sublines 19 and 20 is apt to change before and after supply of additive gas. In this case, the ratio of main gas to be supplied from the first and second shower parts 32a and 32b to the central portion and the edge portion of the wafer 33 is changed. Thus, the main gas could not be distributed in a predetermined amount on the wafer 33.

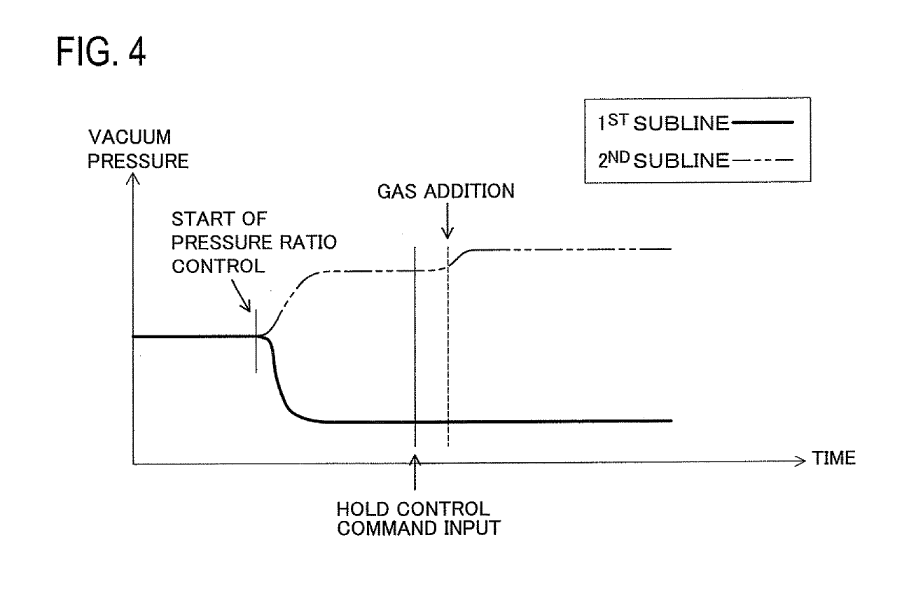

In the present embodiment, however, the pressure ratio control mode is switched to the pressure control mode prior to the supply of additive gas to the second subline 20 as shown in FIG. 4 to maintain the pressure in the first subline constant before and after the supply of additive gas. In other words, the flow rate in the first subline 19 is controlled to be constant. FIG. 4 is a graph showing pressure variations in the first and second sublines 19 and 20 in the ease where additive gas is injected into the second subline 20 during execution of the pressure control mode. In the graph, a vertical axis indicates vacuum pressure and a lateral axis indicates time. Accordingly, even when the additive gas is supplied to the second subline 20, increasing the pressure in the subline 20, the pressure in the first subline 19, that is, the flow rate in the first subline 19 does not change. Thus, the split ratio of main gas to be split into the first and second sublines 19 and 20 is maintained constant before and after supply of additive gas. The ratio of main gas to be supplied to the central portion and the edge portion of the wafer 33 through the first and second sublines 19 and 20 and the first and second shower parts 32a and 32b remains unchanged before and after supply of additive gas. The main gas can therefore be distributed in the predetermined amount on the wafer 33.

Meanwhile, the pressure values measured by the first and second pressure sensors 25A and 25B sometimes fluctuate and change due to disturbance (such as flow rate variations of main gas and ambient temperature variations). In this case, if the pressure control mode is being executed, the controller 26 controls the opening degree of the first fluid control valve 24A to maintain the pressure in the first subline 19 constant. Thus, the ratio of main gas to be supplied to the wafer 33 through the first and second sublines 19 and 20 is liable to change.

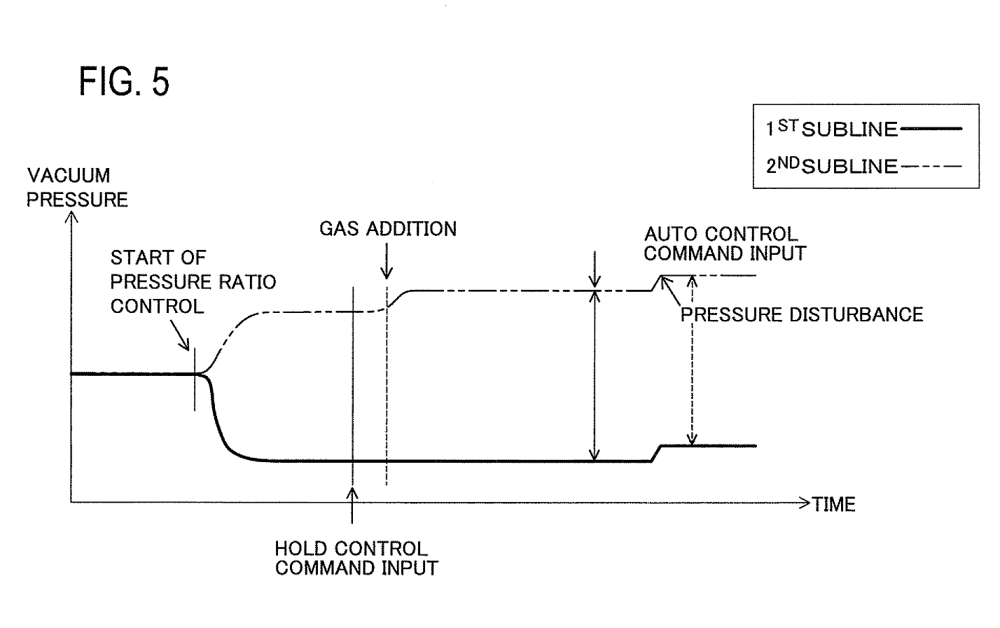

When the additive gas is added to the main gas and then the pressure values measured by the first and second pressure sensors 25A and 25B become stable, the controller 26 transmits a signal indicating to that effect to the central controller 4. The central controller 4 then causes the display part to indicate that execution of AUTO control is enabled to inform the operator thereof. When the operator enters an AUTO control start command into the central controller 4, the central controller 4 outputs the AUTO control command to the controller 26. Upon receipt of the AUTO control command, as shown in FIG. 5, the controller 26 receives the pressure values from the first and second pressure sensors 25A and 25B, calculate a current pressure ratio, and stores it as a second target pressure ratio. The controller 26 then adjusts the opening degree of the first fluid control valve 24A or the second fluid control valve 24B based on the second target pressure ratio to control the pressure in the first and second sublines 19 and 20 at a constant second target pressure ratio.

FIG. 5 is a graph showing pressure variations in the first and second sublines 19 and 20 in the case where disturbance occurs during execution of the pressure ratio control mode. In the graph, a vertical axis indicates vacuum pressure and a lateral axis indicates time.

Since the pressure ratio between the pressure values measured by the first and second pressure sensors 25A and 25B is constant, the main gas is to be split into the first and second sublines 19 and 20 at an almost constant ratio. Accordingly, the pressure values measured by the first and second pressure sensors 25A and 25B become stable at the second target pressure ratio. It is therefore conceivable that the main gas is supplied at a predetermined split flow ratio from the first and second shower parts 32a and 32b.

In the case where the etching gas is distributed on the wafer 33, even when the pressure value measured by the second pressure sensor 25B increases due to disturbance as shown in FIG. 5, the controller 26 controls the opening degree of the first fluid control valve 24A to increase to maintain the second target pressure ratio, thereby increasing the pressure in the first sublime 19. Accordingly, even if the pressure in the second subline 20 varies due to disturbance, the ratio of main gas to be distributed on the central portion and the edge portion of the wafer 33 remains unchanged. A uniform etching rate to the wafer 33 can therefore be provided.

For instance, when the operator inputs an instruction for stopping the apparatus to the central controller 4 due to apparatus troubles or other reasons or when the apparatus is emergency stopped such as emergency situations, e.g., at the time of earthquakes, the central controller 4 outputs a stop command to the controller 26 and closes the main valve 18 and the merging valve 22. Upon receipt of the stop command, the controller 26 executes the stop mode and stops the control of the first and second program valves 24A and 24B and enters a wait state. The controller 26 waits until receiving the pressure ratio control command from the central controller 4.

It is to be noted that when the central controller 4 terminates the process, the controller 26 also terminates the process.

<Operations and Effects>

According to the fluid control method, the fluid control system 1, and the fluid control program, as described above, while the pressure in the first subline 19 is maintained constant to stabilize the flow rate of main gas flowing in the first subline 19, the additive gas is supplied to the second sublime 20. Accordingly, the flow rate of main gas flowing in each of the first and second sublines 19 and 20 remains unchanged before and after the supply of additive gas. This can maintain the split flow ratio of main gas between the first and second sublines 19 and 20 at the same level as before the supply of additive gas.

According to the fluid control method, the fluid control system 1, and the fluid control program, even when the pressure in the first subline 19 or the second subline 20 varies after the supply of additive gas due to disturbance such as flow rate variations of main gas and ambient temperature variations, the pressure in the first subline 19 or the second subline 20 is controlled to maintain the second target pressure ratio and the main gas is supplied at a constant split flow ratio from the main line 17 to the first and second sublines 19 and 20. Therefore, the main gas is split into the first and second sublines 19 and 20 at a constant split flow ratio before and after the disturbance occurs.

When the disturbance occurs after the supply of additive gas as explained above, the split flow ratio of main gas to be split from the main line 17 into the first and second sublines 19 and 20 are maintained constant. Accordingly, the wafer 33 in the chamber 31 is supplied with the main gas at a constant split flow ratio from the first and second sublines 19 and 20, achieving a uniform etching rate, thereby providing high flatness.

The present invention may be embodied in other specific forms without departing from the spirit or essential characteristics thereof.

For instance, the fluid control 1 may be applied not only to manufacture of semiconductors such as an etching work but also control of gas to be split into two lines or circuits in another work.

In the above embodiment, for example, the main gas made of a mixture of the process gasses supplied from the first to third gas supply sources 11A to 11C. As an alternative, valves are placed respectively downstream of the first to third MFCs 13A to 13C for process gas to selectively supply one of the process gases supplied from the first to third gas supply sources 11A to 11C to the main line 17. Regarding the additive gas to be supplied to the merging line 21 from the first and second additive gas supply sources 14A and 14B, similarly, valves may be placed respectively on a secondary side (a downstream side) of the first and second MFCs 16A and 16B for additive gas to selectively supply one of the additive gases.

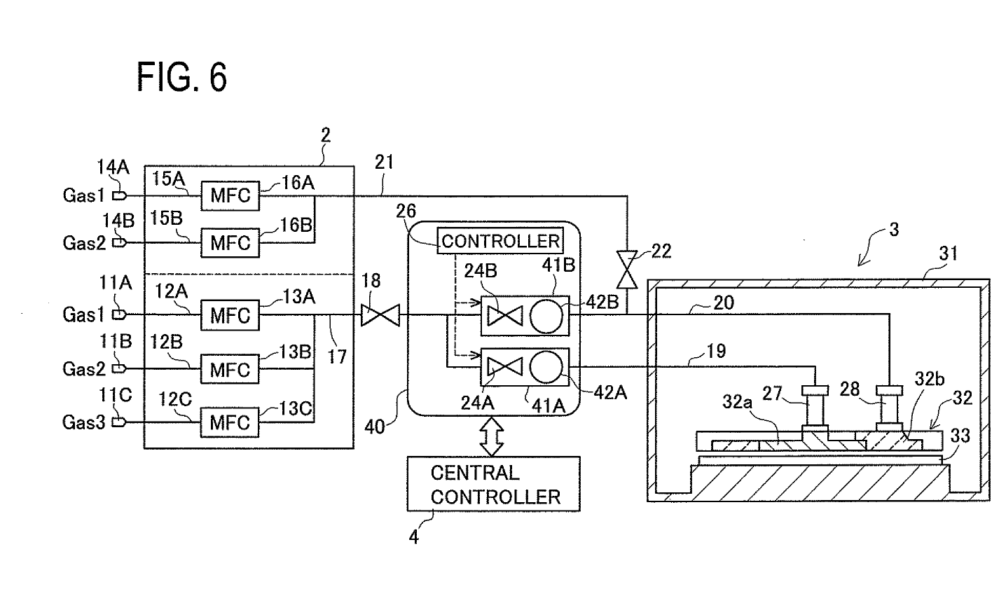

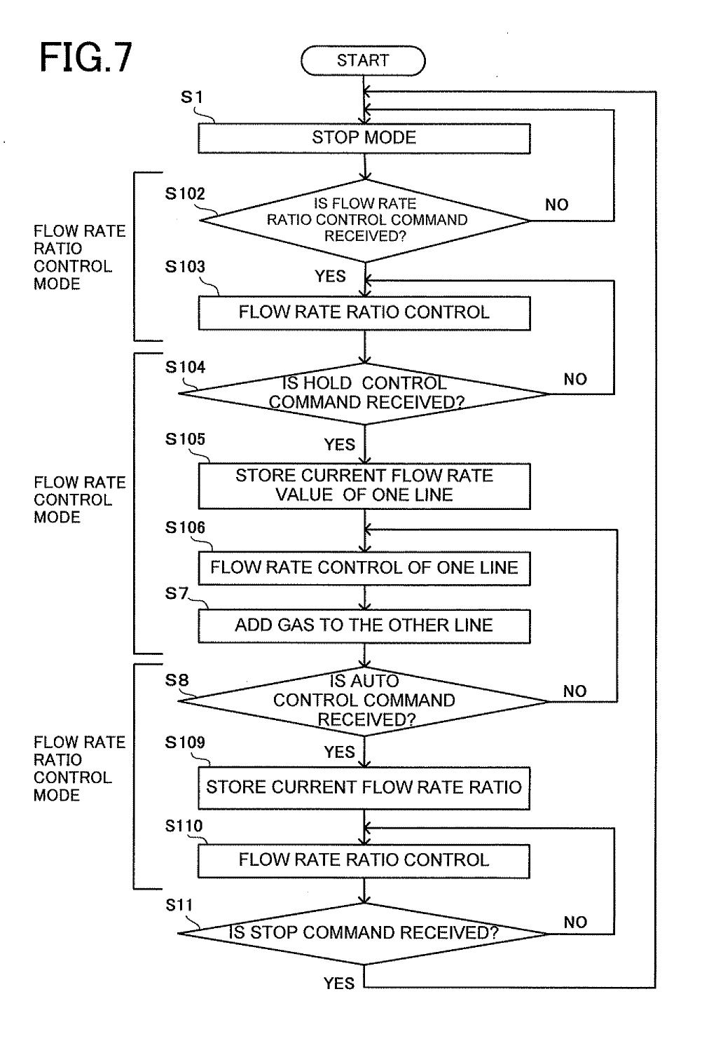

In the above embodiment, for example, the first and second pressure controllers 23A and 23B including the first pressure sensor 25A and the second pressure sensor 25B are used to perform the pressure ratio control and the pressure control. As an alternative, as shown in FIG. 6, a fluid control system 40 may be configured such that first and second flow rate controllers 41A and 41B include first and second mass flowmeters 42A and 42B respectively instead of the first and second pressure sensors 25A and 25B to perform the flow rate ratio control and the flow rate control. In this case, the fluid control system 40 executes the fluid control program shown in FIG. 7 to perform the process by replacing the pressure and the pressure ratio (see FIG. 2) in the above embodiment with flow rate values measured by the first and second mass flowmeters 42A and 42B of the first and second flow rate controllers 41A and 41B and a flow rate ratio calculated based on the flow rate values (S1, S102 to S106, S7, S8, S109, S110, S11) to control the flow rate of main gas to be split into the first and second sublines 19 and 20.

In the above embodiment, the merging line 21 is connected to the line 20 for supplying main gas to the edge portion of the wafer 33 so that the line 19 serves as the “first subline” and the line 20 serves as the “second subline” to thereby supply the additive gas to the edge portion of the wafer 33. To the contrary, in another possible configuration, the merging line 21 is connected to the line 19 but not connected to the line 20 so that the line 20 serves as the “first subline” and the line 19 serves as the “second subline” to thereby supply the additive gas to the central portion of the wafer 33. Even in this case, the pressure control and the pressure ratio control are executed by the same process (see FIG. 2) as in the above embodiment, so that the split flow ratio of main gas to be supplied to the first and second sublines can be maintained constant before and after the supply of additive gas. The same applies to the case of performing the flow rate control and the flow rate ratio control.

While the presently preferred embodiment of the present invention has been shown and described, it is to be understood that this disclosure is for the purpose of illustration and that various changes and modifications may be made without departing from the scope of the invention as set forth in the appended claims.

### REFERENCE SIGNS LIST

1, 40 Fluid control system
17 Main line
19 First subline
20 Second subline
21 Merging line
23A First pressure controller
23B Second pressure controller
31 Chamber
42A First flow rate controller
42B Second flow rate controller

1. A fluid control method for controlling a flow rate of main gas to be supplied from a main line to a chamber through first and second sublines divided from the main line based on pressure in each of the first and second sublines while the second subline is supplied with additive gas,
wherein the pressure in the first subline not supplied with the additive gas is controlled to be constant during supply of the additive gas to the second subline.

2. The fluid control method according to claim 1, wherein
after the additive gas is supplied to the second subline, a pressure ratio between the first and second sublines is determined and stored, the pressure in one of the first and second sublines is adjusted to maintain the stored pressure ratio constant.

3. A fluid control method for controlling a flow rate of main gas to be supplied from a main line to a chamber through first and second sublines divided from the main line based on flow rate in each of the first and second sublines while the second subline is supplied with additive gas,
wherein the flow rate in the first subline not supplied with the additive gas is controlled to be constant during supply of the additive gas to the second subline.

4. The fluid control method according to claim 3, wherein
after the additive gas is supplied to the second subline, a flow rate ratio between the first and second sublines is determined and stored, the flow rate in one of the first and second sublines is adjusted to maintain the stored flow rate ratio constant.

5. A fluid control system comprising: a main line, first and second sublines divided from the main line; a first pressure control unit placed in the first subline; a second pressure control unit placed in the second subline; and a merging line connected to the second subline on a downstream side of the second pressure control unit to supply additive gas into the second subline, the system being configured to control a flow rate of main gas to be allowed to flow in each of the first and second sublines based on the pressure in each of the first and second sublines,
wherein the additive gas is supplied into the second subline while the pressure in the first subline is controlled by the first pressure control unit to maintain the pressure in the first subline constant.

6. The fluid control system according to claim 5, wherein
after the additive gas is supplied to the second subline, a pressure ratio between the first and second sublines is determined and stored, the first and the second pressure control units control the pressure in one of the first and second sublines to maintain the stored pressure ratio constant.

7. A fluid control system comprising: a main line, first and second sublines divided from the main line; a first flow rate control unit placed in the first subline; a second flow rate control unit placed in the second subline; and a merging line connected to the second subline on a downstream side of the second flow rate control unit to supply additive gas into the second subline, the system being configured to control a flow rate of main gas to be allowed to flow in each of the first and second sublines based on the flow rate in each of the first and second sublines,
wherein the additive gas is supplied into the second subline while the flow rate in the first subline is controlled by the first flow rate control unit to maintain the flow rate in the first subline constant.

8. The fluid control system according to claim 7, wherein
after the additive gas is supplied to the second subline, a flow rate ratio between the first and second sublines is determined and stored, the first and the second flow rate control units control the flow rate in one of the first and second sublines to maintain the stored flow rate ratio constant.

9. A non-transitory computer-readable medium storing a fluid control program applicable to a fluid control system comprising: a main line, first and second sublines divided from the main line; a first pressure control unit placed in the first subline; a second pressure control unit placed in the second subline; a merging line connected to the second sublime on a downstream side of the second pressure control unit to supply additive gas into the subline; and a computer for electrically controls the first and second pressure control unites based on the fluid control program, the system being configured to control a flow rate of main gas to be allowed to flow in each of the first and second sublines based on the pressure in each of the first and second sublines,
wherein the program includes operating the computer to cause the first pressure control unit to control the pressure in the first subline to be maintained constant before the additive gas is supplied to the second subline.

10. The non-transitory computer-readable medium storing the fluid control program according to claim 9, wherein
the program includes:
operating the computer to determine a pressure ratio between the first and second sublines when the additive gas is supplied to the second subline after pressure control of the first subline to maintain the pressure in the first subline constant, and
operating the computer to cause the first and second pressure control units to control the pressure of one of the first and second sublines to maintain the determined pressure ratio.

11. A non-transitory computer-readable medium storing a fluid control program applicable to a fluid control system comprising: a main line, first and second sublines divided from the main line; a first flow rate control unit placed in the first subline; a second flow rate control unit placed in the second subline; a merging line connected to the second subline on a downstream side of the second flow rate control unit to supply additive gas into the second subline; and a computer for electrically controls the first and second flow rate control unites based on the fluid control program, the system being configured to control a flow rate of main gas to be allowed to flow in each of the first and second sublines based on the flow rate in each of the first and second sublines,
wherein, the program includes operating the computer to cause the first flow rate control unit to control the flow rate in the first subline to be maintained constant before the additive gas is supplied to the second subline.

12. The non-transitory computer-readable medium storing the fluid control program according to claim 11, wherein
the program includes:
operating the computer to determine a flow rate ratio between the first and second sublines when the additive gas is supplied to the second subline after pressure control of the first sublime to maintain the flow rate in the first subline constant, and
operating the computer to cause the first and second flow rate control units to control the flow rate in one of the first and second sublines to maintain the determined flow rate ratio.
